(19) United States
(12) Patent Application Publication
(10) Pub. No.: US 2026/0037164 A1
(43) Pub. Date: Feb. 5, 2026

(54) POWER LOSS NOTIFICATION POWER PROCESSING FOR MEMORY SYSTEMS

(71) Applicant: Micron Technology, Inc., Boise, ID (US)

(72) Inventor: John E. Maroney, Irvine, CA (US)

(21) Appl. No.: 19/276,797

(22) Filed: Jul. 22, 2025

Related U.S. Application Data
(60) Provisional application No. 63/677,305, filed on Jul. 30, 2024.
(60) Provisional application No. 63/704,968, filed on Oct. 8, 2024.

(51) Int. Cl. G06F 3/06

(52) U.S. Cl. CPC G06F 3/0625; G06F 3/0653; G06F 3/0679

(57) ABSTRACT

Methods, systems, and devices for power loss notification (PLN) power processing for memory systems are described. A memory device may be coupled with power loss backup circuitry that is external to the memory device. The power loss backup circuitry may detect a loss of a power supply and may utilize a PLN to notify the memory device of the power loss. The power loss backup circuitry may provide a backup power supply to the memory device while the memory device prepares for shutdown. The memory device may use the PLN, a power loss acknowledgment (PLA) indication, and a logging mechanism to verify that a duration over which the backup power is supplied is sufficient to support a complete shutdown operation, including the reliable flush of data to non-volatile memory without error. The PLN and logging mechanism described herein provides for reliable and efficient power loss processing.

### CROSS REFERENCES

The present Application for Patent claims priority to U.S. Patent Application No. 63/677,305 by Maroney, entitled “POWER LOSS NOTIFICATION POWER PROCESSING FOR MEMORY SYSTEMS,” filed Jul. 30, 2024, and U.S. Patent Application No. 63/704,968 by Maroney, entitled “POWER LOSS NOTIFICATION POWER PROCESSING FOR MEMORY SYSTEMS,” filed Oct. 8, 2024, which are assigned to the assignee hereof, and which are expressly incorporated by reference in their entirety herein.

### TECHNICAL FIELD

The following relates to one or more systems for memory, including power loss notification power processing for memory systems.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports power loss notification (PLN) power processing for memory systems in accordance with examples as disclosed herein.

FIG. 2 shows an example of a system that supports PLN power processing for memory systems in accordance with examples as disclosed herein.

FIG. 3 shows an example of a timing diagram that supports PLN power processing for memory systems in accordance with examples as disclosed herein.

FIG. 4 shows an example of a state diagram that supports PLN power processing for memory systems in accordance with examples as disclosed herein.

FIG. 5 shows a block diagram of a memory system that supports PLN power processing for memory systems in accordance with examples as disclosed herein.

FIGS. 6 and 7 show flowcharts illustrating a method or methods that support PLN power processing for memory systems in accordance with examples as disclosed herein.

### DETAILED DESCRIPTION

Some memory systems may include a module, such as a solid state drive (SSD), that is large enough to include memory as well as capacitors and other hardware configured to facilitate power backups for the memory. For example, a power loss protection (PLP) circuit may be on the same module as the SSD. The PLP circuit may provide sufficient power for a shutdown if a power supply is lost, and no function to notify the module of a shutdown may be needed. However, in some use cases, such as automotive cases, the module size may be relatively small and may not support power backup circuitry such as a PLP circuit on the module. If the module includes volatile and non-volatile memory, the volatile data may be flushed for proper data retention during power off, which may take time, but the module may not be notified of the power loss. Techniques for handling a shutdown of a memory system during an asynchronous power loss (APL) event based on an indication of power loss may be beneficial for systems in which the power loss backup circuitry is not included on the same module as the memory (e.g., volatile and non-volatile memory).

Techniques described herein provide for power loss processing in a system including a memory device (e.g., an SSD module) coupled with other circuitry, including power loss backup circuitry, that is external to the memory device. In such cases, a memory system as described herein may utilize a power loss notification (PLN) function to notify the memory device of a power loss. The memory device may use the PLN, a power loss acknowledgment (PLA) indication, and a logging mechanism to verify that a duration for which a host system triggers PLN and provides backup power supports a PLP power up vault time for the memory system. The PLP power up vault time may be a threshold duration for the memory device to shut down using backup power and may be advertised in a product data sheet or a standard for the memory system. If the host timing is insufficient or if the host system ends backup power supply early, the memory device may detect this via the logging mechanism and may indicate an error. The memory device may assert the PLA signal until the memory system completes a corresponding shut down operation, which may be either a forced quiescence (FQ) operation or an emergency power failure (EPF) operation, and may sample the PLN signal and log the samples periodically during this time to determine if the PLN was asserted for the full duration of the flush, which may provide for the memory device to identify potential errors caused by lack of power during a full shutdown operation, among other examples.

In addition to applicability in memory systems as described herein, techniques for PLN power processing for memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving shutdown operations in the case of power loss in a memory system including volatile and non-volatile memory, which may decrease processing or latency times, improve data retention, and improve overall performance of the memory system upon reboot, among other benefits.

In addition to applicability in memory systems described herein, techniques for PLN power processing for memory systems may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by improving the reliability of data within a memory system by, for example, ensuring the data is flushed and stored properly prior to a shutdown operation, among other examples, which may prevent or mitigate unauthorized access to data or other information, incur lower latency costs (e.g., by implementing it at hardware level), and improve reliability of data within the memory system, among other benefits.

Features of the disclosure are illustrated and described in the context of systems, devices, and circuits. Features of the disclosure are further illustrated and described in the context of memory systems, timing diagrams, state diagrams, and flowcharts.

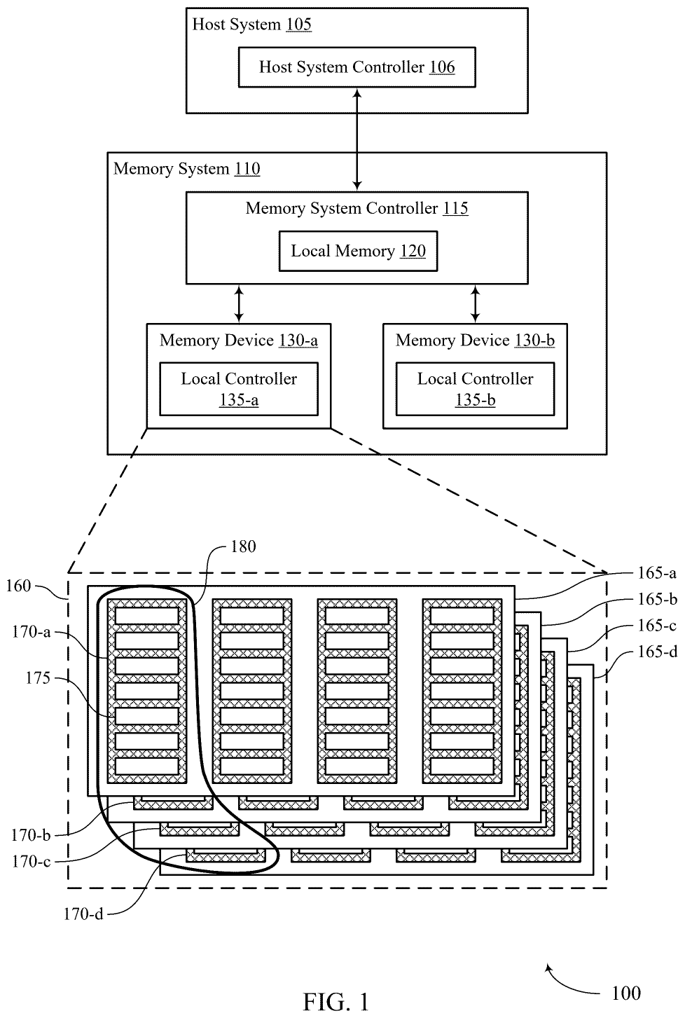

FIG. 1 shows an example of a system 100 that supports PLN power processing for memory systems in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions, processor-executable code) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b,165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

In some examples, if the memory system 110 does not include any volatile memory, one or more techniques may be performed in the event of a power loss, such as, a claw back from a cache (e.g., recovery or shutdown operations). The power loss processing state in such system may be enabled or disabled via one or more commands, but loss of data may be less of a risk than in systems that include volatile memory.

The memory system 110 may include a power management system (e.g., PMIC) and power backup circuitry for backing up one or more memory devices 130 in a power failure event. The one or more memory devices 130 may be, for example, SSDs, or other types of modules including both volatile and non-volatile memory. In some examples, the memory device(s) 130 and the power management circuitry may be included on a same module that is coupled with the host system 105. For example, the memory system 110 may be a single module or may include one or more modules that each include at least one memory device 130 and power management circuitry (e.g., self-contained), which may include one or more PLP capacitors and a PMIC with PLP support. Such a memory system 110 may not depend on the host system 105 or other power or control, at least because the power management circuitry may identify a power loss and provide sufficient backup power for a proper shutdown. There may not be any PLN in such systems.

In some examples, such as automotive use cases, among other examples, the size of a module may be relatively small, such that an individual module may include volatile and non-volatile memory and a local controller 135, but may not include the power management circuitry. In such cases, external communication with the host system 105 may be necessary to detect and recover from APL and other power loss events. As described herein, the power backup circuitry may be external to a module that includes the one or more memory devices 130, and techniques for detecting a power loss (e.g., APL), notifying the memory device 130 of the power loss, and then handling a shutdown of the memory device reliably are described.

Techniques described herein provide for power loss processing in the memory system 110 including a memory device 130 (e.g., an SSD module) coupled with other circuitry, including power loss backup circuitry, that is external to the memory device 130. In such cases, the memory system 110 as described herein may utilize a PLN function to notify the memory device 130 of a power loss. The memory device 130 may use the PLN, a PLA indication, and a logging mechanism to verify that a host system 105 utilizes PLN and power backup timing that supports a PLP power up vault time for the memory system 110. The PLP power up vault time may be a threshold duration for which the backup circuitry may provide power for the memory device 130 to shut down and may be advertised in a product data sheet or a standard for the memory system 110. If the timing of the host system 105 is insufficient or if the host system 105 ends backup power supply early, the memory device 130 may indicate an error. The memory device 130 may assert the PLA signal until the memory system 110 completes a corresponding shut down operation, which may be either a FQ operation or an EPF operation, and may sample the PLN signal and log the samples periodically during this time to determine if the PLN was asserted for the full duration of the flush, which may provide for the memory device 130 to identify potential errors caused by lack of power during a full shutdown operation, among other examples.

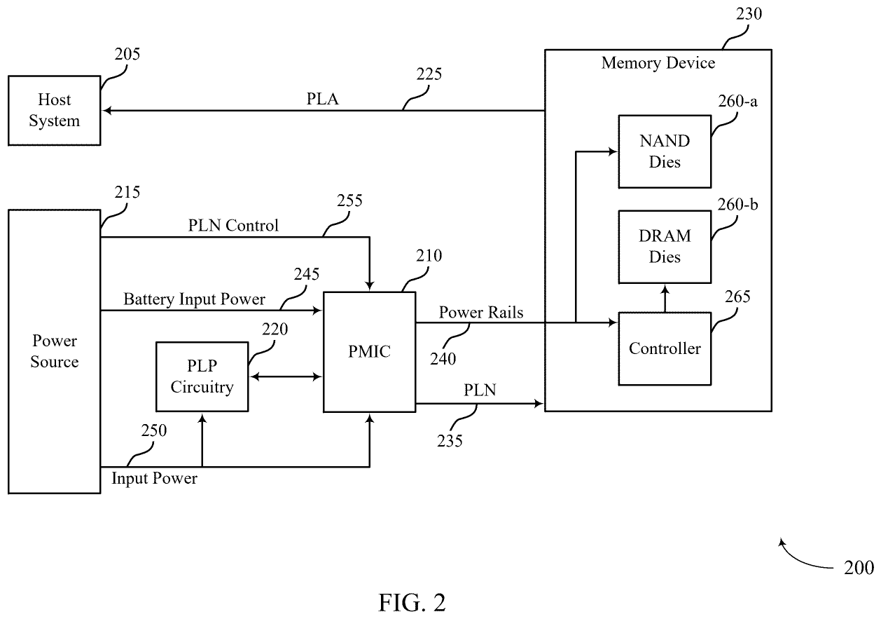

FIG. 2 shows an example of a system 200 that supports PLN power processing for memory systems in accordance with examples as disclosed herein. The system 200 may implement or be implemented by aspects of the system 100 described with reference to FIG. 1. For example, the system 200 may represent an example of the memory system 110 or the system 100 as described with reference to FIG. 1. The system 200 may include or otherwise be coupled with a host system 205 and a memory device 230, which may represent examples of the host system 105 and the memory devices 130 as described with reference to FIG. 1. In this example, the system 200 may include a PMIC 210, PLP circuitry 220, and other power management circuitry that is configured to detect a power loss, notify the memory device 230 of the power loss, and provide backup power services for at least a duration after the power loss is detected.

In some examples, the memory device 230 may be a memory module, such as an SSD module or some other type of module (e.g., a ball grid array package) that is relatively small. The memory device 230 may include one or more non-volatile dies 260-a (e.g., NAND dies) and one or more volatile memory dies 260-b (e.g., DRAM dies). The volatile dies 260-b may support extra workloads for certain applications, such as enterprise-like workloads caused by multiport, single root I/O virtualization (SR-IOV), or centralized storage, among other examples. The memory device 230 may include a controller 265 (e.g., an automotive SSD controller die) that facilitates the transfer of data between the memory dies and the host system 205. However, the memory device 230 may not include any power management circuitry (e.g., due to the module being relatively small or other space constraints). The volatile dies 260-b may store information such as logical-to-physical (L2P) data and other cached data that may not be maintained in volatile storage if the memory device 230 loses power. Thus, techniques for preserving such volatile data during a power loss using external power management and backup circuitry may be beneficial.

The power management and backup circuitry may include, for example, the PMIC 210 and the PLP circuitry 220, which may be external to the module including the memory device 230. For example, the PMIC 210 and the PLP circuitry may be included on a customer's motherboard. Techniques described herein facilitate synchronization and communication between the external power management and backup circuitry and the memory device 230 to provide for the memory device 230 to successfully perform a shutdown operation in the event of a power loss.

The host system 205 may include or otherwise be coupled with a power source 215, which may be a battery, as an example, that provides power to the system 200. The power source 215 may provide the input power 250, which may be volatile input power, to the PMIC 210 and the PLP circuitry 220, which may include one or more capacitors (e.g., 35 volt capacitors, or some other size). The input power 250 may charge the PLP circuitry 220, such that the PLP circuitry 220 holds a threshold voltage level during operation of the system. The power source 215 may further provide the battery input power 245 to the PMIC 210. In some examples, the power source 215 may operate according to instructions from the host system 205.

The PMIC 210 may provide (e.g., forward) the power to the memory device 230 via one or more power rails 240 (e.g., BGA SSD power rails, such as PLP, PWR1, PWR2, and PWR3). The memory device 230 may operate using the power provided via the power rails 240 (e.g., voltage rails). The PMIC 210 as described herein may support both PLP and PLN. That is, the PMIC 210 and the PLP circuitry 220 may facilitate detection and notification of a power loss, as well as protection during the power loss by, for example, providing a backup power to the memory device 230 for some duration.

A power loss event may be detected by the PMIC 210 or the host system 205. If the host system 205 detects or otherwise schedules a power off, or a drop in power below a threshold, the host system 205 may instruct the power source 215 to reduce the supplied input power 250 and battery input power 245 (e.g., reduce to some threshold or turn off completely). In some examples, the host system 205 may indicate such a drop in power to the power source 215, which may convey, to the PMIC 210 via an optional key-off PLN control 255, a notification of the power loss (e.g., or reduction). Additionally, or alternatively, the PMIC 210 may monitor the input power 250, the battery input power 245, or both, and may detect if the input voltage drops below a threshold voltage (e.g., a threshold power). If the PMIC 210 detects a drop below the threshold voltage, the PMIC 210 may determine a power loss scenario, in some cases.

As described herein, the PMIC 210 may indicate a power loss to the memory device 230 using a PLN 235. In response to detection of the power loss scenario from the PLN control 255 or monitoring of the input power, the PMIC 210 may assert the PLN 235, which may be a pin or other signal to the memory device 230. As described herein, the PLN 235 may be a notification to the memory device 230, by circuitry external to the memory device 230 (e.g., PLN generated from hardware energy backup circuits that detect input power loss), that a power loss is occurring. The memory device 230 may be configured to acknowledge the PLN 235 via a PLA 225 back to the host system 205. The PLA may be another signal or pin between the memory device 230 and the host system 205.

Once the PLN 235 is asserted, the PLP circuitry 220 may provide a backup power source for the memory device 230. That is, the power backup and management circuitry may ensure that power rails 240 to the memory device 230 are within operating limits for at least a threshold duration (e.g., a vault time), which may be indicated in a product data sheet and may be an amount of time for the memory device 230 to reliably shut down (e.g., to flush data to the NAND dies 260-a safely). For example, the PLP circuitry 220 may include one or more capacitors that discharge voltage via the PMIC 210 and the one or more power rails 240 to the memory device 230 for some duration. The backup power may provide for the memory device 230 to successfully perform and complete a shutdown operation, which may include protecting or otherwise retaining data stored in the one or more volatile dies 260-b.

The power management circuitry may thereby be external to the memory device 230, and may detect and notify the memory device 230 of a power loss event using a PLN 235. The power management circuitry may subsequently provide backup power for the memory device 230 during the power loss, which may improve reliability of relatively small memory modules including both volatile and non-volatile memory.

The power management and backup circuitry may provide the backup power in response to assertion of the PLN 235. A duration for which the PLP circuitry 220 is powered on and provides power to the memory device 230 via the power rails 240 may be based on the PLN 235 being asserted, in some examples. For example, the PLP circuitry 220 may be powered on when the PLN 235 is asserted and may be powered off when the PLN 235 is not asserted, in some examples. If the PLP circuitry 220 powers down or stops providing backup power before the memory device 230 has completed a shutdown operation, there may be one or more errors in data stored by the memory device 230. Accordingly, techniques for the memory device 230 to verify the shutdown operation was completed before the power was turned off may provide for the memory device 230 to ensure the data was stored properly prior to shut down.

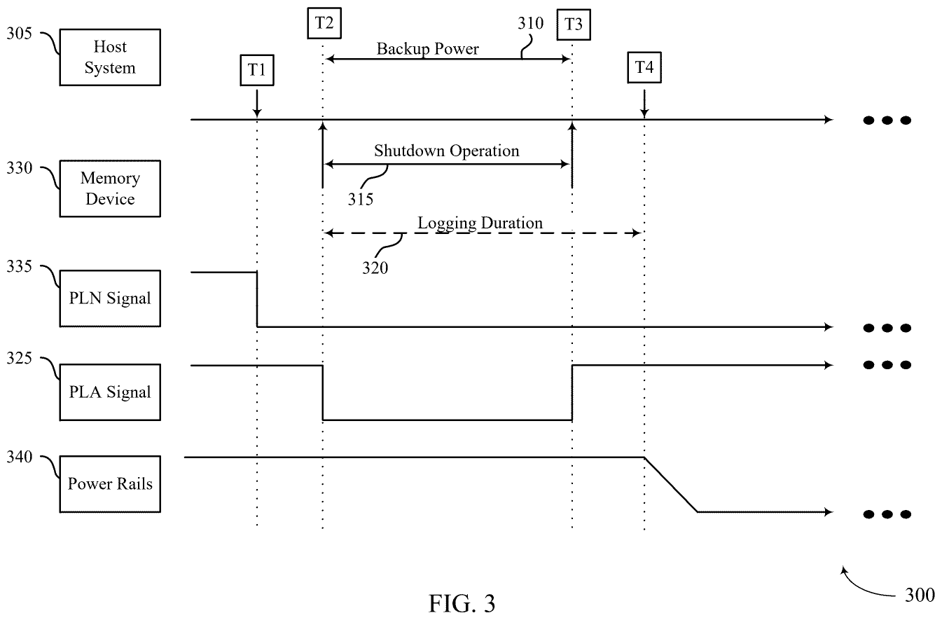

Techniques described herein provide for a PLP power processing mechanism in which the PLN 235 may not be interrupted and the memory device 230 may log PLN timing information to verify the timing aspects and shutdown accuracy. For example, the PLN 235 may be a continuous signal that is not interrupted until after a shutdown operation by the memory device 230 is complete. The memory device 230 may de-assert the PLA 225 in response to completing the shutdown operation. That is, after the memory device 230 successfully flushes data, metadata, or both to the NAND dies 260-a, the memory device 230 may de-assert the PLA 225 to indicate completion of the shutdown operation. The PLN 235 may be de-asserted after the host system 205 receives an indication of the de-asserted PLA 225. Timing of the PLN 235, PLA 225, and shutdown operations are described in further detail elsewhere herein, including with reference to FIG. 3.

As described herein, the memory device 230 may verify that valid power timing is met for the controller 265 (e.g., firmware in the memory device 230) to complete a flush of data by sampling the PLN 235. The memory device 230 may actively monitor the PLN 235 to determine whether the backup timing is met or not (e.g., whether the PLN 235 is asserted long enough). For example, the memory device 230 may sample the PLN 235 periodically (e.g., every 1 millisecond) or according to some other interval during the power up time. The memory device 230 may store the samples in a log file at the memory device 230 (e.g., in the NAND dies 260-a). The memory device 230 may compare the samples with some threshold value (e.g., zero) to determine if the PLN 235 remains asserted long enough for the shutdown operation and corresponding flush of data to be completed.

By sampling the PLN 235, the memory device 230 may determine whether any errors due to inadequate power may have occurred during a shutdown operation. For example, if one or more of the samples of the PLN 235 are less than the threshold value (e.g., zero), or if the PLN timing log records less than the flush time, this may indicate that the PLN 235 did not remain asserted during the shutdown operation and that at least a portion of the data may not have been properly flushed prior to a power loss. In such cases, the memory device 230 may indicate, to the host system 205, one or more errors (e.g., uncorrectable ECC (UECC) or some other type of error). Additionally, or alternatively, the memory device 230 may take other corrective actions to correct the errors.

The system 200 may thereby support power loss detection, indication, and backup by power management and backup circuitry that is external to the memory device 230 (e.g., an SSD) using a PLN 235 and PLA 225. To verify accuracy of the power loss mechanism and the corresponding shutdown operation performed by the memory device 230, the memory device 230 may sample the PLN 235 and log the samples during the shutdown operation. The samples may indicate whether the PLN 235 remained asserted for the entire flush duration or not, which may provide for the memory device 230 to proactively detect and correct potential errors caused by abrupt loss of power before the data is properly retained.

FIG. 3 shows an example of a timing diagram 300 that supports PLN power processing for memory systems in accordance with examples as disclosed herein. The timing diagram 300 may implement or be implemented by aspects of the system 100 and the system 200, as described with reference to FIGS. 1 and 2. For example, the timing diagram 300 illustrates voltages and signal levels associated with a power loss processing mechanism performed by a host system 305, a memory device 330, and power management and backup circuitry (e.g., the PMIC 210), which may represent examples of corresponding devices and circuitry as described with reference to FIG. 2. The timing diagram 300 illustrates the changes in voltages and signal levels over time as power to the memory device 330 is lost and a shutdown operation is performed. FIG. 3 may not be shown to scale to allow for clearer illustration and description; the various voltage and signal levels, as well as the corresponding durations may be smaller or larger than shown

In the timing diagram 300, the PLN signal 335 may represent an example of signal levels of the PLN 235, the PLA signal 325 may represent an example of signal levels of the PLA 225, and the power rails 340 may represent examples of voltages on the power rails 240 described with reference to FIG. 2.

During operation of the memory device 330, the power rails 340 may have a first voltage level to facilitate the operations. For example, the host system 305 may provide, via the power source 215 and the PMIC 210 described with reference to FIG. 2, a supply voltage to the memory device 330 during operations. At some time T1, the host system 305 (e.g., a host backup circuit) may detect an input voltage drop. For example, the host system 305 may initiate a power off. Additionally, or alternatively, the power management and backup circuitry may monitor a voltage supplied by a power source, and may detect if the voltage drops below some threshold. The host system 305 may send the PLN signal 335 in response to detecting the input voltage drop. The PLN signal 335 may be a pin or other channel between the PMIC and the memory device 330, as described and illustrated with reference to FIG. 2.

In some examples, sending the PLN signal 335 may be referred to as asserting the PLN signal 335, and may include setting a signal level or pin value to a low value, as illustrated in FIG. 3. However, it is to be understood that any value or signal level may indicate a power loss is detected. In some examples, there may be a delay (e.g., a propagation delay) before the memory device 330 receives or detects the change in the PLN signal 335, which may be referred to as a PLN interrupt response time, in some examples.

At a second time T2, the memory device 330 may detect the change in the PLN signal 335 and may send the PLA signal 325 to the host system 305. In some examples, sending the PLA signal 325 may be referred to as asserting the PLA signal 325, and may include setting a signal level or pin value to a low value (e.g., a first value), as illustrated in FIG. 3. However, it is to be understood that any value or signal level may indicate an acknowledgment that the memory device 330 successfully received the PLN signal 335. The PLA signal 325 may be set by a controller of the memory device 330, such as the controller 265 described with reference to FIG. 2.

The memory device 330 may start monitoring one or more voltage rails at or after the second time T2. For example, the memory device 330 may check a voltage on the power rails 340 periodically or according to some other interval starting at the same time as or after the memory device 330 asserts the PLA signal 325. The memory device 330 may additionally, or alternatively, monitor a voltage level of the PLN signal 335 (e.g., the PLN pin) and may log the voltage level of the PLN signal 335. Each time the memory device 330 checks the voltage level on the power rails, the PLN signal 335 (e.g., PLN asserted low level), or both, the memory device 330 may store metadata, data, or some other indication of the voltage level in a log file. The logging may begin after the memory device 330 asserts the PLA signal 325. In some examples, the log file may map the voltage level of the voltage rails, the PLN signal 335, or both to a corresponding time stamp at which the voltage level was monitored. The log file may be stored in non-volatile memory of the memory device 330, in some examples. The memory device 330 may perform the logging for some logging duration 320 while the memory device 330 performs a shutdown operation 315.

The memory device 330 may initiate the shutdown operation 315 at the second time T2 in response to detecting the change in the PLN signal 335. The shutdown operation 315 may include one or more processes to flush any data to non-volatile memory for retention while the memory device 330 is powered down, among other operations to prepare for a shutdown and a subsequent reboot of the memory device 330.

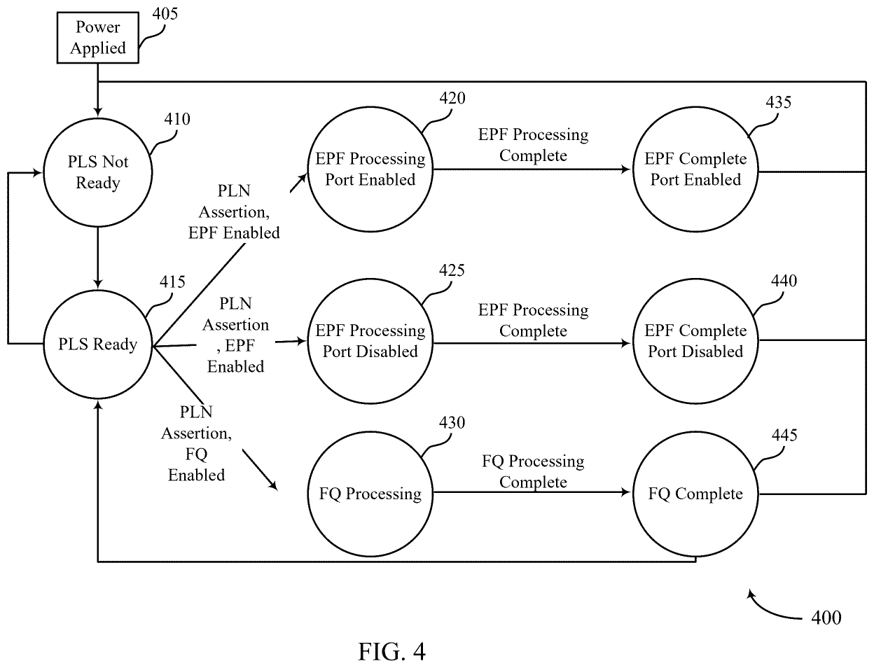

In some examples, the shutdown operation 315 may be a relatively quick operation in which the most important data (e.g., data associated with safety, device operation or other relatively critical applications) is flushed. In such cases, a subsequent reboot operation may be relatively complicated to, for example, recover the necessary information and continue operations after a quick shutdown. Such a shutdown operation 315 may be an emergency power failure (EPF) operation, for example. Additionally, or alternatively, the shutdown operation 315 may take a relatively longer time, but may include flushing both data and metadata, such as L2P information, among other metadata, to prepare the memory device 330 for a relatively quick and clean reboot process. Such a shutdown operation 315 may be referred to as an FQ operation, for example. The EPF and FQ operations are described in further detail elsewhere herein, including with reference to FIG. 4.

The memory device 330 may perform a supported type of shutdown operation 315 during a duration in which the power backup circuitry may supply a backup power 310, which may be referred to as a backup power duration, a vault time, a holdup time, or the like. The backup power duration may be indicated for a given product via a product data sheet, in some examples. For example, a customer motherboard may advertise that it supports some threshold (e.g., minimum) backup power duration (e.g., vault time). The memory device 330 may thereby perform the shutdown operation 315 to be complete within the same amount of time as or less than the amount of time included in the backup power duration.

At a third time T3, the memory device 330 may complete the shutdown operation 315 and may re-assert the PLA signal 325. In some examples, the guaranteed backup power time may end at the same time T3. Additionally, or alternatively, the guaranteed backup power time may end after the time T3.

There may be some delay between the time T3 at which the memory device 330 de-asserts the PLA signal 325 and the time T4 at which the host system 305 receives or detects the change in the PLA signal 325. The PLA signal 325 being de-asserted may indicate that the memory device 330 successfully shut down and saved data and that the backup power may be turned off. The host system 305 may thereby terminate the backup power supply at the fourth time T4 in response to the de-assertion of the PLA signal 325. That is, the host system 305 may deactivate the power backup and management circuitry. In some other examples, the host system 305 may deactivate the power backup and management circuitry at the end of the guaranteed power backup time (e.g., if the guaranteed power backup time ends later than the time at which the PLA signal 325 is de-asserted or instead of waiting for the PLA signal 325).

The memory device 330 may continue logging the level of the PLN signal 335 for the logging duration 320, which may end at the time T3 in response to the memory device 330 de-asserting the PLA signal 325. Additionally, or alternatively, the memory device 330 may continue the logging duration 320 until the power is shut off at time T4. The memory device 330 may retrieve the log file including the PLN signal 335 information upon a reboot or at some other time, and may determine whether the voltage level of the PLN signal 335 remained above some threshold for at least the duration of the shutdown operation 315. That is, the memory device 330 may use the log information to determine whether the PLN signal 335 remained asserted, which may indicate whether the backup power 310 remained sufficient for a complete and reliable shutdown operation 315. If the log information indicates that the PLN signal 335 was de-asserted (e.g., dropped below a threshold voltage) at any point during the logging duration 320, this may indicate that the backup power 310 dropped at any point or for some threshold amount of time during the shutdown operation 315. In such cases, the memory device 330 may indicate, to the host system 305 or a controller, that there may be an error to be fixed or otherwise accounted for.

At time T4, in response to the host system 305 terminating the backup power, the voltage on the power rails 340 may reduce to zero. For example, the power level conveyed via the power rails 340 may deplete to zero power over some time period.

The system 200 may thereby support signal and pin timings according to the timing diagram 300 to ensure that a memory module is notified of a power loss and is able to correctly and reliable flush data as part of a shutdown operation 315 before the module loses power altogether. By receiving the PLN signal 335 and logging information associated with the PLN signal 335, an input supply voltage, or both, the memory device may improve accuracy and reliability of data storage over time.

FIG. 4 shows an example of a state diagram 400 that supports PLN power processing for memory systems in accordance with examples as disclosed herein. The state diagram 400 may implement or be implemented by aspects of the system 100, the system 200, and the timing diagram 300, as described with reference to FIGS. 1 through 3. For example, the state diagram 400 illustrates various states associated with a memory system when a power loss is detected and a shutdown operation is performed. In this example, a shutdown operation may not be interrupted before completion.

At 405, an input supply power may be applied to the memory device 230. For example, the power source 215 may supply an input power via the power rails 240.

The memory device 230 (e.g., module) may enter a power loss signaling (PLS) not ready state 410 based on one or more commands. For example, if the memory device 230 has one or more commands, such as a shutdown command, in a command queue or otherwise pending execution, the memory device 230 may enter the PLS not ready state 410, which may indicate that the memory device 230 is not ready to receive any signaling associated with power loss.

In some examples, the memory device 230 may automatically enter the PLS not ready state 410 when power is applied at 405, and the memory device 230 may remain in the PLS not ready state 410 until enabled.

The memory device 230 may transition from the state 410 to the PLS ready state 415 once the memory device 230 clears its command queue (e.g., CSTS=00b). That is, if there is no shutdown command, the memory device 230 may enter the PLS ready state 415. In some examples, a memory controller, such as the local controller 265 in FIG. 2, may enable the memory device 230 to enter the PLS ready state 415 (e.g., by setting a command value to zero, or the like). In some examples, the memory device may transition back to the PLS not ready state 410 from the PLS ready state 415 in response to one or more commands (e.g., a CSTS or NSSR command to abort PLN assert).

While operating in the PLS ready state 415, the memory device 230 may monitor for a PLN signal. In some cases, a PLN signal may be asserted. For example, a host system, power backup circuitry, or both, may detect a power loss (e.g., a reduction in power below some threshold) and may assert the PLN to notify the memory device 230. In response to detecting the PLN assertion, the memory device 230 may transition from the PLS ready state 415 to a shutdown data processing state. The memory device 230 may receive one or more set feature commands while operating in the PLS ready state 415, in some examples. The set feature commands may enable one or more types of power shutdown processing. The one or more types may include EPF and FQ, among other examples of power shutdown processing types. Each type may be associated with a respective shutdown duration, a shutdown procedure, and the like. For example, different types and amounts of data may be flushed for different types of shutdown processing operations. In some examples, the EPF processing may be associated with a relatively shorter duration for shutdown, and may include flushing less data than the FQ processing. The FQ processing may include flushing relatively large amounts of data and metadata, such as L2P mapping information, and the like.

The memory device 230 may transition from the PLS ready state 415 to the EPF processing port enabled state 420 if the PLN is asserted, EPF is enabled, and the memory device 230 supports EPF processing port enabled state. The EPF may be enabled (e.g., or disabled) via the one or more set feature commands. Additionally, or alternatively, the EPF processing port enabled state 420 may be a default state for the memory device 230. That is, if the memory device 230 does not receive a set feature command and the PLN is asserted, the memory device 230 may default to a default state for processing, which may be the EPF processing port enabled state 420, in some examples.

The memory device 230 may perform EPF processing (e.g., a shutdown operation) while in either the EPF port processing enabled state 420 or the EPF port processing disabled state 425. The memory device 230 may not be able to exit the EPF port processing enabled state 420 or the EPF port processing disabled state 425 before the EPF processing is complete. For example, because the PLN assertion may not be interrupted, no other commands or signals may interrupt the PLN assertion and the corresponding shutdown operation (e.g., EPF processing) until the operation is complete and the PLN is de-asserted. That is the EPF processing port enabled state 420 and the EPF port processing disabled state 425 may not be interrupted by, for example, a controller reset or shutdown command. In some examples, the PLN may remain asserted for at least a vault time associated with the EPF processing, which may correspond to a maximum duration for the memory device 230 to complete an EPF shutdown operation. The PLN may remain asserted without interruption due to, for example, hardware that asserts the PLN or some type of conditional statement in firmware, or the like.

In response to entering the EPF processing port enabled state 420 or the EPF port processing disabled state 425, the memory device 230 may assert the PLA signal, as described with reference to FIGS. 2 and 3 and may refrain from fetching commands on any submission queue. In some examples, a value of the PLA signal may indicate whether the port is enabled or disabled. The EPF processing may include processing port communications, aborting any non-committed write commands and outstanding read commands, refraining from completing any admin commands, and flushing any in-flight input/output commands that are already committed. The EPF processing may further include preparing for power loss in a manner that may or may not allow command processing to resume quickly in the event of power loss and then power resumption. If the PLN is asserted and the memory device 230 transitions to the EPF processing port enabled state 420, but the PLN is subsequently de-asserted without any intervening loss of main power, controller level reset, or shutdown, the memory device 230 may resume fetching and processing commands.

Once the EPF processing is complete, the memory device 230 may transition from the EPF processing port enabled state 420 to the EPF complete port enabled state 435 or from the EPF port processing disabled state 425 to the EPF complete port disabled state 440. The memory device 230 may de-assert the PLA signal in response to entering the EPF complete port enabled state 435 or the EPF complete port disabled state 440. In some examples, the power may be lost after the PLA is de-asserted. Once the PLA is de-asserted and power is regained the memory device 230 may transition back to the PLS not ready state 410 and may resume operations. In some examples, if the memory device 230 is in the EPF complete port disabled state 440, the PLN may remain asserted until after the PLA is de-asserted or after a power cycle. If the memory device 230 is in the EPF complete port enabled state 435, the PLN may remain asserted until after the PLA is de-asserted or until the memory device 230 is back in the PLS ready state 415.

In some examples, the memory device 230 may transition from the EPF complete port enabled state 435 to the PLS ready state 415 (e.g., skipping the PLS not ready state 410) if the PLN is de-asserted without a power cycle.

The memory device 230 may transition from the PLS ready state 415 to the FQ processing state 430 if the PLN is asserted and FQ is enabled. The FQ may be enabled (e.g., or disabled) via the one or more set feature commands. Additionally, or alternatively, the FQ processing state 430 may be a default state for the memory device 230. That is, if the memory device 230 does not receive a set feature command and the PLN is asserted, the memory device 230 may default to a default state for processing, which may be the FQ processing state 430, in some examples.

In response to entering the FQ processing state 430, the memory device 230 may assert the PLA signal, as described with reference to FIGS. 2 and 3 and may stop (e.g., immediately) fetching commands on any submission queue. Any commands fetched from a submission queue prior to entry to the FQ processing state 430, as well as any commands received out-0of-band on a management endpoint prior to entry to the FQ processing state 430, may be discarded. The FQ processing may include processing port communications, aborting any non-committed write input/output commands and outstanding read input/output commands, refraining from completing any admin commands, and flushing any in-flight input/output commands that are already committed to allow for a clean shutdown. Additionally, or alternatively, the FQ processing may include preparing for power loss in a manner that allows command processing to resume relatively quickly (e.g., clean shutdown) in the event of power loss and subsequent power resumption.

The memory device 230 may not be able to exit the FQ processing state 430 before the FQ processing is complete. For example, because the PLN assertion may not be interrupted, no other commands or signals may interrupt the PLN assertion and the corresponding shutdown operation (e.g., FQ processing) until the operation is complete and the PLN is de-asserted. That is the FQ processing state 430 may not be interrupted by, for example, a controller reset or shutdown command. In some examples, the PLN may remain asserted for at least a vault time associated with the FQ processing, which may correspond to a maximum duration for the memory device 230 to complete an FQ shutdown operation. The PLN may remain asserted without interruption due to, for example, hardware that asserts the PLN or some type of conditional statement in firmware, or the like.

Once the FQ processing is complete, the memory device 230 may transition from the FQ processing state 430 to the FQ complete state 445. The memory device 230 may de-assert the PLA signal in response to entering the FQ complete state 445. In some examples, the power may be lost after the PLA is de-asserted. Once the PLA is de-asserted and power is regained the memory device 230 may transition back to the PLS not ready state 410 and may resume operations or back to the PLS ready state 415. The PLN may remain asserted until the memory device 230 is back in the PLS ready state 415. In some examples, the memory device 230 may transition from the EPF complete port enabled state 435 to the PLS ready state 415 (e.g., skipping the PLS not ready state 410) if the PLN is de-asserted without a power cycle.

The memory device 230 described herein (e.g., the controller, the firmware, hardware, or any combination thereof) may thereby transition from the PLS ready state 415 to a processing state, where the memory device 230 may remain until a full shutdown operation is complete and the associated data is flushed successfully. By not permitting a transition from any of the processing states back to the PLS not ready state 410 or the PLS ready state 415, the memory device 230 may ensure that a full shutdown operation is successfully completed before power is shut off completely, which may improve reliability, among other examples.

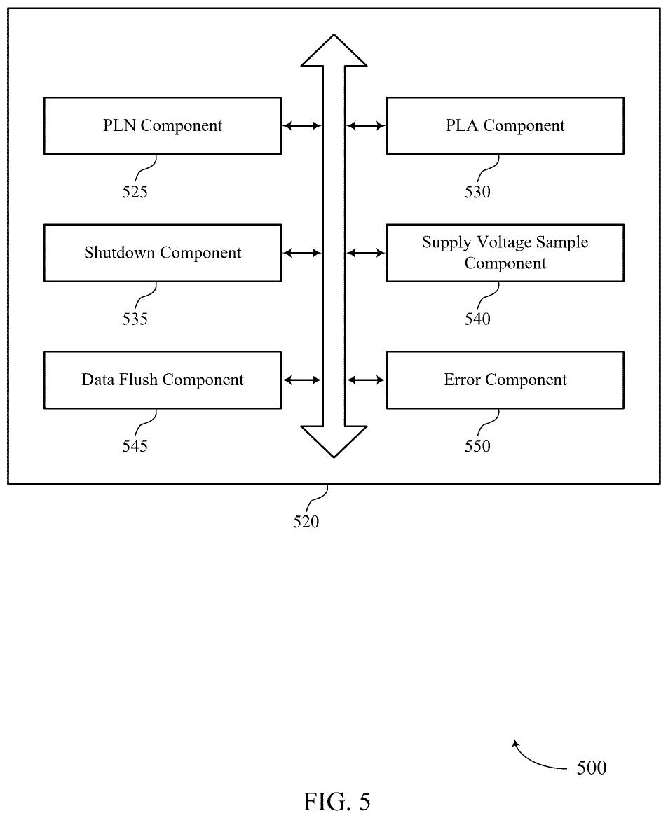

FIG. 5 shows a block diagram 500 of a memory system 520 that supports PLN power processing for memory systems in accordance with examples as disclosed herein. The memory system 520 may be an example of aspects of a memory system as described with reference to FIGS. 1 through 4. The memory system 520, or various components thereof, may be an example of means for performing various aspects of PLN power processing for memory systems as described herein. For example, the memory system 520 may include an PLN component 525, a PLA component 530, a shutdown component 535, a supply voltage sample component 540, a data flush component 545, an error component 550, or any combination thereof. Each of these components, or components of subcomponents thereof (e.g., one or more processors, one or more memories), may communicate, directly or indirectly, with one another (e.g., via one or more buses).

The PLN component 525 may be configured as or otherwise support a means for receiving, at a memory device from power management circuitry that is external to the memory device, a PLN that indicates a decrease from a first supply power level for the memory device to a second supply power level for the memory device. The PLA component 530 may be configured as or otherwise support a means for setting, at a first time, an acknowledgment signal to a first value, where the first value of the acknowledgment signal indicates receipt of the PLN. The shutdown component 535 may be configured as or otherwise support a means for performing, using the first supply power level, a shutdown operation based at least in part on setting the acknowledgment signal to the first value. In some examples, the PLA component 530 may be configured as or otherwise support a means for setting, at a second time, the acknowledgment signal to a second value, where the second value of the acknowledgment signal indicates a completion of the shutdown operation.

In some examples, to support performing the shutdown operation, the data flush component 545 may be configured as or otherwise support a means for flushing, during a duration between the first time and the second time, data from a volatile memory to a non-volatile memory of the memory device, the shutdown operation including an emergency power failure operation, where resumption of operations of the memory device after the shutdown operation may be associated with a command processing resumption duration that is greater than a threshold duration based at least in part on the emergency power failure operation.

In some examples, to support performing the shutdown operation, the data flush component 545 may be configured as or otherwise support a means for flushing, during a duration between the first time and the second time, one or more logical-to-physical mapping tables and corresponding data from a volatile memory to a non-volatile memory of the memory device, the shutdown operation including a forced quiescence operation, where resumption of operations of the memory device after the shutdown operation may be associated with a command processing resumption duration that is less than a threshold duration based at least in part on the forced quiescence operation.

In some examples, the supply voltage sample component 540 may be configured as or otherwise support a means for obtaining one or more samples of a power loss notification signal level supplied to the memory device between the first time and the second time. In some examples, the supply voltage sample component 540 may be configured as or otherwise support a means for storing the one or more samples of the voltage level in a log file at the memory device.

In some examples, to support obtaining the one or more samples of the voltage level, the supply voltage sample component 540 may be configured as or otherwise support a means for obtaining the one or more samples according to a sampling periodicity.

In some examples, the supply voltage sample component 540 may be configured as or otherwise support a means for obtaining one or more samples of a voltage level supplied to the memory device during a duration between the first time and the second time. In some examples, the supply voltage sample component 540 may be configured as or otherwise support a means for comparing the one or more samples of the voltage level with a threshold voltage level.

In some examples, the error component 550 may be configured as or otherwise support a means for transmitting an error indication associated with data flushed as part of the shutdown operation during the duration based at least in part on at least one sample of the one or more samples of the voltage level being less than the threshold voltage level during the duration.

In some examples, the PLN indicates a threshold duration associated with a backup supply power for the memory device. In some examples, the threshold duration is the same as or greater than a difference between the first time and the second time. In some examples, the memory device maintains the first supply power level between the first time and the second time based at least in part on the backup supply power.

In some examples, one or more voltage rails coupled with the memory device convey a first voltage level associated with the first supply power level before the second time. In some examples, the one or more voltage rails convey a second voltage level associated with the second supply power level after the second time based at least in part on the acknowledgment signal being set to the second value at the second time.

In some examples, the second supply power level is associated with no power supplied to the memory device.

In some examples, the PLN component 525 may be configured as or otherwise support a means for receiving a PLN that indicates a duration before a decrease from a first supply power level for a memory device to a second supply power level for the memory device. The supply voltage sample component 540 may be configured as or otherwise support a means for monitoring, for at least the duration, a voltage level on one or more voltage rails coupled with the memory device. In some examples, the supply voltage sample component 540 may be configured as or otherwise support a means for storing information that indicates one or more samples of the voltage level on the one or more voltage rails at one or more times during the duration. In some examples, the shutdown component 535 may be configured as or otherwise support a means for determining whether one or more operations executed during the duration were successful based at least in part on the one or more samples.

In some examples, the supply voltage sample component 540 may be configured as or otherwise support a means for comparing the one or more samples of the voltage level with a threshold voltage level. In some examples, the shutdown component 535 may be configured as or otherwise support a means for determining that the one or more operations were successful based at least in part on the one or more samples being greater than or equal to the threshold voltage level.

In some examples, the supply voltage sample component 540 may be configured as or otherwise support a means for comparing the one or more samples of the voltage level with a threshold voltage level. In some examples, the shutdown component 535 may be configured as or otherwise support a means for determining that at least one operation of the one or more operations was not successful based at least in part on at least one sample of the one or more samples being less than the threshold voltage level.

In some examples, the error component 550 may be configured as or otherwise support a means for transmitting, based at least in part on determining that at least one operation of the one or more operations was not successful, an error notification that indicates an error in data stored by the memory device.

In some examples, the error notification includes an uncorrectable error correction code.

In some examples, the PLA component 530 may be configured as or otherwise support a means for asserting a power loss acknowledgment indication based at least in part on the PLN. In some examples, the PLA component 530 may be configured as or otherwise support a means for de-asserting the power loss acknowledgment indication based at least in part on completing execution of the one or more operations.

In some examples, the shutdown component 535 may be configured as or otherwise support a means for performing the one or more operations during the duration based at least in part on the PLN, the one or more operations including one or more shutdown operations associated with flushing data to non-volatile memory within the memory device.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

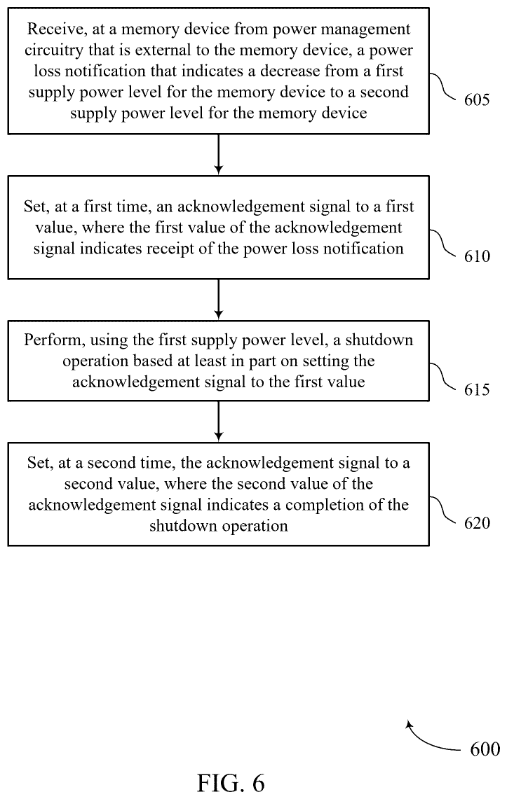

FIG. 6 shows a flowchart illustrating a method 600 that supports PLN power processing for memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving, at a memory device from power management circuitry that is external to the memory device, a PLN that indicates a decrease from a first supply power level for the memory device to a second supply power level for the memory device. In some examples, aspects of the operations of 605 may be performed by an PLN component 525 as described with reference to FIG. 5.

At 610, the method may include setting, at a first time, an acknowledgment signal to a first value, where the first value of the acknowledgment signal indicates receipt of the PLN. In some examples, aspects of the operations of 610 may be performed by a PLA component 530 as described with reference to FIG. 5.

At 615, the method may include performing, using the first supply power level, a shutdown operation based at least in part on setting the acknowledgment signal to the first value. In some examples, aspects of the operations of 615 may be performed by a shutdown component 535 as described with reference to FIG. 5.

At 620, the method may include setting, at a second time, the acknowledgment signal to a second value, where the second value of the acknowledgment signal indicates a completion of the shutdown operation. In some examples, aspects of the operations of 620 may be performed by a PLA component 530 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, at a memory device from power management circuitry that is external to the memory device, a PLN that indicates a decrease from a first supply power level for the memory device to a second supply power level for the memory device; setting, at a first time, an acknowledgment signal to a first value, where the first value of the acknowledgment signal indicates receipt of the PLN; performing, using the first supply power level, a shutdown operation based at least in part on setting the acknowledgment signal to the first value; and setting, at a second time, the acknowledgment signal to a second value, where the second value of the acknowledgment signal indicates a completion of the shutdown operation.

Aspect 2: The method, apparatus, or non-transitory computer-readable medium of aspect 1, where performing the shutdown operation includes operations, features, circuitry, logic, means, or instructions, or any combination thereof for flushing, during a duration between the first time and the second time, data from a volatile memory to a non-volatile memory of the memory device, the shutdown operation including an emergency power failure operation, where resumption of operations of the memory device after the shutdown operation may be associated with a command processing resumption duration that is greater than a threshold duration based at least in part on the emergency power failure operation.

Aspect 3: The method, apparatus, or non-transitory computer-readable medium of any of aspects 1 through 2, where performing the shutdown operation includes operations, features, circuitry, logic, means, or instructions, or any combination thereof for flushing, during a duration between the first time and the second time, one or more logical-to-physical mapping tables and corresponding data from a volatile memory to a non-volatile memory of the memory device, the shutdown operation including a forced quiescence operation, where resumption of operations of the memory device after the shutdown operation may be associated with a command processing resumption duration that is less than a threshold duration based at least in part on the forced quiescence operation.

Aspect 4: The method, apparatus, or non-transitory computer-readable medium of any of aspects 1 through 3, further including operations, features, circuitry, logic, means, or instructions, or any combination thereof for obtaining one or more samples of a PLN signal level supplied to the memory device between the first time and the second time and storing the one or more samples of the PLN signal level in a log file at the memory device.

Aspect 5: The method, apparatus, or non-transitory computer-readable medium of aspect 4, where obtaining the one or more samples of the PLN signal level includes operations, features, circuitry, logic, means, or instructions, or any combination thereof for obtaining the one or more samples according to a sampling periodicity.

Aspect 6: The method, apparatus, or non-transitory computer-readable medium of any of aspects 1 through 5, further including operations, features, circuitry, logic, means, or instructions, or any combination thereof for obtaining one or more samples of a PLN signal level supplied to the memory device during a duration between the first time and the second time and comparing the one or more samples of the PLN signal level with a threshold voltage level.

Aspect 7: The method, apparatus, or non-transitory computer-readable medium of aspect 6, further including operations, features, circuitry, logic, means, or instructions, or any combination thereof for transmitting an error indication associated with data flushed as part of the shutdown operation during the duration based at least in part on at least one sample of the one or more samples of the PLN signal level being less than the threshold voltage level during the duration.

Aspect 8: The method, apparatus, or non-transitory computer-readable medium of any of aspects 1 through 7, where the PLN indicates a threshold duration associated with a backup supply power for the memory device; the threshold duration is the same as or greater than a difference between the first time and the second time; and the memory device maintains the first supply power level between the first time and the second time based at least in part on the backup supply power.

Aspect 9: The method, apparatus, or non-transitory computer-readable medium of any of aspects 1 through 8, where one or more voltage rails coupled with the memory device convey a first voltage level associated with the first supply power level before the second time and the one or more voltage rails convey a second voltage level associated with the second supply power level after the second time based at least in part on the acknowledgment signal being set to the second value at the second time.

Aspect 10: The method, apparatus, or non-transitory computer-readable medium of any of aspects 1 through 9, where the second supply power level is associated with no power supplied to the memory device.

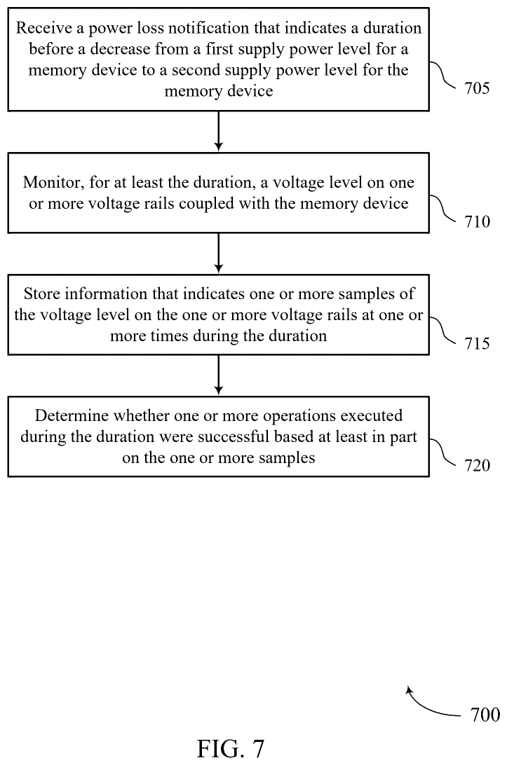

FIG. 7 shows a flowchart illustrating a method 700 that supports PLN power processing for memory systems in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving a PLN that indicates a duration before a decrease from a first supply power level for a memory device to a second supply power level for the memory device. In some examples, aspects of the operations of 705 may be performed by an PLN component 525 as described with reference to FIG. 5.

At 710, the method may include monitoring, for at least the duration, a voltage level on one or more voltage rails coupled with the memory device. In some examples, aspects of the operations of 710 may be performed by a supply voltage sample component 540 as described with reference to FIG. 5.

At 715, the method may include storing information that indicates one or more samples of the voltage level on the one or more voltage rails at one or more times during the duration. In some examples, aspects of the operations of 715 may be performed by a supply voltage sample component 540 as described with reference to FIG. 5.

At 720, the method may include determining whether one or more operations executed during the duration were successful based at least in part on the one or more samples. In some examples, aspects of the operations of 720 may be performed by a shutdown component 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 11: A method, apparatus, or non-transitory computer-readable medium including operations, features, circuitry, logic, means, or instructions, or any combination thereof for receiving a PLN that indicates a duration before a decrease from a first supply power level for a memory device to a second supply power level for the memory device; monitoring, for at least the duration, a voltage level on one or more voltage rails coupled with the memory device; storing information that indicates one or more samples of the voltage level on the one or more voltage rails at one or more times during the duration; and determining whether one or more operations executed during the duration were successful based at least in part on the one or more samples.

Aspect 12: The method, apparatus, or non-transitory computer-readable medium of aspect 11, further including operations, features, circuitry, logic, means, or instructions, or any combination thereof for monitoring the PLN for the duration, wherein determining whether the one or more operations executed during the duration were successful is further based at least in part on monitoring the PLN.

Aspect 13: The method, apparatus, or non-transitory computer-readable medium of aspects 11 through 12, further including operations, features, circuitry, logic, means, or instructions, or any combination thereof for comparing the one or more samples of the voltage level with a threshold voltage level and determining that the one or more operations were successful based at least in part on the one or more samples being greater than or equal to the threshold voltage level.

Aspect 14: The method, apparatus, or non-transitory computer-readable medium of any of aspects 11 through 13, further including operations, features, circuitry, logic, means, or instructions, or any combination thereof for comparing the one or more samples of the voltage level with a threshold voltage level and determining that at least one operation of the one or more operations was not successful based at least in part on at least one sample of the one or more samples being less than the threshold voltage level.

Aspect 15: The method, apparatus, or non-transitory computer-readable medium of any of aspects 11 through 14, further including operations, features, circuitry, logic, means, or instructions, or any combination thereof for transmitting, based at least in part on determining that at least one operation of the one or more operations was not successful, an error notification that indicates an error in data stored by the memory device.

Aspect 16: The method, apparatus, or non-transitory computer-readable medium of aspect 15, where the error notification includes an uncorrectable error correction code.

Aspect 17: The method, apparatus, or non-transitory computer-readable medium of any of aspects 11 through 16, further including operations, features, circuitry, logic, means, or instructions, or any combination thereof for asserting a power loss acknowledgment indication based at least in part on the PLN and de-asserting the power loss acknowledgment indication based at least in part on completing execution of the one or more operations.

Aspect 18: The method, apparatus, or non-transitory computer-readable medium of any of aspects 11 through 17, further including operations, features, circuitry, logic, means, or instructions, or any combination thereof for performing the one or more operations during the duration based at least in part on the PLN, the one or more operations including one or more shutdown operations associated with flushing data to non-volatile memory within the memory device.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 19: A memory system, including: a memory module including volatile memory and non-volatile memory; power management circuitry coupled with the memory module, the power management circuitry configured to: provide a supply voltage to the memory module; monitor a level of the supply voltage; and transmit a PLN to the memory module based at least in part on the level of the supply voltage decreasing below a threshold voltage level; and power backup circuitry configured to provide a backup supply voltage to the memory module for at least a duration based at least in part on the PLN.

Aspect 20: The memory system of aspect 19, where the power management circuitry is configured to continuously maintain the PLN for at least the duration.

Aspect 21: The memory system of any of aspects 19 through 20, where the power backup circuitry includes one or more capacitors configured to store the backup supply voltage and configured to discharge, based at least in part on an activation of the power backup circuitry, the backup supply voltage.

Aspect 22: The memory system of any of aspects 19 through 21, where the power management circuitry is configured to: activate the power backup circuitry based at least in part on the supply voltage decreasing below the threshold voltage level, where the power backup circuitry is configured to provide the backup supply voltage to the memory module via the power management circuitry based at least in part on the activation.

Aspect 23: The memory system of any of aspects 19 through 22, where the memory module is configured to: transmit a power loss acknowledgment to a host system coupled with the memory system based at least in part on the PLN.

Aspect 24: The memory system of any of aspects 19 through 23, where the memory module includes shutdown processing circuitry configured to flush, as part of a shutdown operation, data to the non-volatile memory within the memory module based at least in part on the PLN.

Aspect 25: The memory system of aspect 24, where the shutdown operation includes a forced quiescence operation associated with flushing the data and logical-to-physical mapping information or an emergency power failure operation associated with flushing the data.

Aspect 26: The memory system of any of aspects 24 through 25, where the shutdown processing circuitry is configured to complete the flush of the data continuously during the duration based at least in part on the PLN transmitted by the power management circuitry.

Aspect 27: The memory system of any of aspects 19 through 26, where the memory module includes: one or more first memory dies including the volatile memory; one or more second memory dies including the non-volatile memory; and one or more controllers configured to facilitate data transfer between the one or more first memory dies and the one or more second memory dies.

Aspect 28: The memory system of any of aspects 19 through 27, where the power management circuitry includes a power management integrated circuit that supports PLN functions and power loss protection functions.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a memory module comprising volatile memory and non-volatile memory;
power management circuitry coupled with the memory module, the power management circuitry configured to:
provide a supply voltage to the memory module;
monitor a level of the supply voltage; and
transmit a power loss notification to the memory module based at least in part on the level of the supply voltage decreasing below a threshold voltage level; and
power backup circuitry configured to provide a backup supply voltage to the memory module for at least a duration based at least in part on the power loss notification.

2. The memory system of claim 1, wherein the power management circuitry is configured to continuously maintain the power loss notification for at least the duration.

3. The memory system of claim 1, wherein the power backup circuitry comprises one or more capacitors configured to store the backup supply voltage and configured to discharge, based at least in part on an activation of the power backup circuitry, the backup supply voltage.

4. The memory system of claim 1, wherein the power management circuitry is configured to:
activate the power backup circuitry based at least in part on the supply voltage decreasing below the threshold voltage level, wherein the power backup circuitry is configured to provide the backup supply voltage to the memory module via the power management circuitry based at least in part on the activation.

5. The memory system of claim 1, wherein the memory module is configured to:
transmit a power loss acknowledgment to a host system coupled with the memory system based at least in part on the power loss notification.

6. The memory system of claim 1, wherein the memory module comprises shutdown processing circuitry configured to flush, as part of a shutdown operation, data to the non-volatile memory within the memory module based at least in part on the power loss notification.

7. The memory system of claim 6, wherein the shutdown operation comprises a forced quiescence operation associated with flushing the data and logical-to-physical mapping information or an emergency power failure operation associated with flushing the data.

8. The memory system of claim 6, wherein the shutdown processing circuitry is configured to complete the flush of the data continuously during the duration based at least in part on the power loss notification transmitted by the power management circuitry.

9. The memory system of claim 1, wherein the memory module comprises:
one or more first memory dies comprising the volatile memory;
one or more second memory dies comprising the non-volatile memory; and
one or more controllers configured to facilitate data transfer between the one or more first memory dies and the one or more second memory dies.

10. The memory system of claim 1, wherein the power management circuitry comprises a power management integrated circuit that supports power loss notification functions and power loss protection functions.

11. An apparatus, comprising:
one or more memories storing processor-executable code; and
one or more processors coupled with the one or more memories and individually or collectively operable to execute the code to cause the apparatus to:
receive, at a memory device from power management circuitry that is external to the memory device, a power loss notification that indicates a decrease from a first supply power level for the memory device to a second supply power level for the memory device;
set, at a first time, an acknowledgment signal to a first value, wherein the first value of the acknowledgment signal indicates receipt of the power loss notification;
perform, using the first supply power level, a shutdown operation based at least in part on setting the acknowledgment signal to the first value; and
set, at a second time, the acknowledgment signal to a second value, wherein the second value of the acknowledgment signal indicates a completion of the shutdown operation.

12. The apparatus of claim 11, wherein the one or more processors are individually or collectively further operable to execute the code to cause the apparatus to:
obtain one or more samples of a power loss notification signal level supplied to the memory device between the first time and the second time; and
store the one or more samples of the power loss notification signal level in a log file at the memory device.

13. The apparatus of claim 12, wherein, to obtain the one or more samples of the power loss notification signal level, the one or more processors are individually or collectively operable to execute the code to cause the apparatus to:
obtain the one or more samples according to a sampling periodicity.

14. The apparatus of claim 11, wherein the one or more processors are individually or collectively further operable to execute the code to cause the apparatus to:
obtain one or more samples of a power loss notification signal level supplied to the memory device during a duration between the first time and the second time; and
compare the one or more samples of the power loss notification signal level with a threshold voltage level.

15. The apparatus of claim 14, wherein the one or more processors are individually or collectively further operable to execute the code to cause the apparatus to:
transmit an error indication associated with data flushed as part of the shutdown operation during the duration based at least in part on at least one sample of the one or more samples of the power loss notification signal level being less than the threshold voltage level during the duration.

16. The apparatus of claim 11, wherein, to perform the shutdown operation, the one or more processors are individually or collectively operable to execute the code to cause the apparatus to:
flush, during a duration between the first time and the second time, data from a volatile memory to a non-volatile memory of the memory device, the shutdown operation comprising an emergency power failure operation, wherein resumption of operations of the memory device after the shutdown operation may be associated with a command processing resumption duration that is greater than a threshold duration based at least in part on the emergency power failure operation.

17. The apparatus of claim 11, wherein, to perform the shutdown operation, the one or more processors are individually or collectively operable to execute the code to cause the apparatus to:
flush, during a duration between the first time and the second time, one or more logical-to-physical mapping tables and corresponding data from a volatile memory to a non-volatile memory of the memory device, the shutdown operation comprising a forced quiescence operation, wherein resumption of operations of the memory device after the shutdown operation may be associated with a command processing resumption duration that is less than a threshold duration based at least in part on the forced quiescence operation.

18. The apparatus of claim 11, wherein:
the power loss notification indicates a threshold duration associated with a backup supply power for the memory device;
the threshold duration is a same as or greater than a difference between the first time and the second time; and
the memory device maintains the first supply power level between the first time and the second time based at least in part on the backup supply power.

19. The apparatus of claim 11, wherein:
one or more voltage rails coupled with the memory device convey a first voltage level associated with the first supply power level before the second time; and
the one or more voltage rails convey a second voltage level associated with the second supply power level after the second time based at least in part on the acknowledgment signal being set to the second value at the second time.

20. The apparatus of claim 11, wherein the second supply power level is associated with no power supplied to the memory device.

21. An apparatus, comprising:
one or more memories storing processor-executable code; and
one or more processors coupled with the one or more memories and individually or collectively operable to execute the code to cause the apparatus to:
receive a power loss notification that indicates a duration before a decrease from a first supply power level for a memory device to a second supply power level for the memory device;
monitor, for at least the duration, a voltage level on one or more voltage rails coupled with the memory device;
store information that indicates one or more samples of the voltage level on the one or more voltage rails at one or more times during the duration; and
determine whether one or more operations executed during the duration were successful based at least in part on the one or more samples.

22. The apparatus of claim 21, wherein the one or more processors are individually or collectively further operable to execute the code to cause the apparatus to:
monitor the power loss notification for the duration, wherein determining whether the one or more operations executed during the duration were successful is further based at least in part on monitoring the power loss notification.

23. The apparatus of claim 21, wherein the one or more processors are individually or collectively further operable to execute the code to cause the apparatus to:
compare the one or more samples of the voltage level with a threshold voltage level; and
determine that the one or more operations were successful based at least in part on the one or more samples being greater than or equal to the threshold voltage level.

24. The apparatus of claim 21, wherein the one or more processors are individually or collectively further operable to execute the code to cause the apparatus to:
compare the one or more samples of the voltage level with a threshold voltage level; and
determine that at least one operation of the one or more operations was not successful based at least in part on at least one sample of the one or more samples being less than the threshold voltage level.

25. The apparatus of claim 21, wherein the one or more processors are individually or collectively further operable to execute the code to cause the apparatus to:
transmit, based at least in part on determining that at least one operation of the one or more operations was not successful, an error notification that indicates an error in data stored by the memory device.

26. The apparatus of claim 25, wherein the error notification comprises an uncorrectable error correction code.

27. The apparatus of claim 21, wherein the one or more processors are individually or collectively further operable to execute the code to cause the apparatus to:
assert a power loss acknowledgment indication based at least in part on the power loss notification; and
de-assert the power loss acknowledgment indication based at least in part on completing execution of the one or more operations.

28. The apparatus of claim 21, wherein the one or more processors are individually or collectively further operable to execute the code to cause the apparatus to:
perform the one or more operations during the duration based at least in part on the power loss notification, the one or more operations comprising one or more shutdown operations associated with flushing data to non-volatile memory within the memory device.

29. A method, comprising:
receiving, at a memory device from power management circuitry that is external to the memory device, a power loss notification that indicates a decrease from a first supply power level for the memory device to a second supply power level for the memory device;
setting, at a first time, an acknowledgment signal to a first value, wherein the first value of the acknowledgment signal indicates receipt of the power loss notification;
performing, using the first supply power level, a shutdown operation based at least in part on setting the acknowledgment signal to the first value; and
setting, at a second time, the acknowledgment signal to a second value, wherein the second value of the acknowledgment signal indicates a completion of the shutdown operation.

30. A method, comprising:
receiving a power loss notification that indicates a duration before a decrease from a first supply power level for a memory device to a second supply power level for the memory device;
monitoring, for at least the duration, a voltage level on one or more voltage rails coupled with the memory device;
storing information that indicates one or more samples of the voltage level on the one or more voltage rails at one or more times during the duration; and
determining whether one or more operations executed during the duration were successful based at least in part on the one or more samples.
